(19) United States
(12) Patent Application Publication
(10) Pub. No.: US 2017/0030295 A1
(43) Pub. Date: Feb. 2, 2017

(54) STIRLING CYCLE ENGINE

(71) Applicant: Twinbird Corporation, Tsubame-shi (JP)

(72) Inventors: Mineyuki INOUE, Tsubame-shi (JP); Jun TANIKAWA, Tsubame-shi (JP); Takeshi SUZUKI, Tsubame-shi (JP)

(73) Assignee: Twinbird Corporation, Tsubame-shi (JP)

(21) Appl. No.: 15/222,414

(22) Filed: Jul. 28, 2016

(30) Foreign Application Priority Data
Jul. 31, 2015 (JP) 2015-152745

(51) Int. Cl. F02G 1/057

(52) U.S. Cl. CPC F02G 1/057

(57) ABSTRACT

Provided is a thermally efficient Stirling cycle engine including: a casing; a cylinder housed within the casing; a piston reciprocatable inside said cylinder; a displacer reciprocatable with a phase difference relative to the piston; a compression chamber defined between the piston and the displacer; an expansion chamber arranged on a first side of the displacer with a second side thereof opposite to the compression chamber; a heat exhausting unit arranged in the neighborhood of the compression chamber; a heat absorbing unit arranged in the neighborhood of the expansion chamber; a regenerator arranged between the heat exhausting unit and the heat absorbing unit; and a heat exhausting chamber defined between an outer surface of the casing and an inner surface of the heat exhausting unit, said heat exhausting chamber in communication with the compression chamber and the regenerator respectively through a first passage and a second passage provided in the casing.

### CROSS-REFERENCE TO RELATED APPLICATIONS

This application claims a priority to Japanese Patent Application No. 2015-152745, filed Jul. 31, 2015, the entirety of which is hereby incorporated herein by reference.

### BACKGROUND OF THE INVENTION

Field of the Invention

The present invention relates to a Stirling cycle engine, particularly to a Stirling cycle engine in which a piston and a displacer are positioned coaxially to each other.

Description of the Related Art

Conventionally, as a Stirling cycle engine of such type, there has been disclosed a Stirling cycle engine in e.g., Japanese un-examined patent application publication No. 2013-68362 (hereinafter referred to as '362 publication), provided with a cylinder, a piston, a displacer, and a driving mechanism that are arranged inside of a casing. Here, the majority portion of the casing is composed of a cylindrical portion, a body portion and a coupling member, all of which are generally formed of a comparatively thick stainless steel material. One of the reasons for employing such material is because it is necessary to make a leakage of helium less likely to occur since helium, which is the nearest to the ideal gas and prone to be leaked, is often used as an operating gas encapsulated in the casing of such Stirling cycle engine. Other reasons therefor are because the casing needs to be manufactured from a metal capable of withstanding a high pressure as an operating gas is encapsulated therein at a high pressure; and stainless steel is relatively inexpensive and has an excellent workability and corrosion resistance.

However, the Stirling cycle engine of such a type as is disclosed in '362 publication has a disadvantage of not being capable of exhausting heat in an efficient manner since a heat generated in a compression chamber is to be exhausted from heat exhausting fins through a cylindrical portion that is formed of a stainless steel material. There may be provided some heat exhausting unit around the casing, whereby heat-exhaust efficiency can be improved on some level. However, what it comes down to is that such system employs the same mechanism as the above-mentioned system to the extent that the heat is exhausted through a casing, posing an obstacle to the improvement of heat-exhaust efficiency.

It is, therefore, an object of the present invention to solve the above-mentioned problems and provide a Stirling cycle engine having an enhanced overall heat efficiency through the improvement of heat exhausting efficiency.

### SUMMARY OF THE INVENTION

A first aspect of the present invention is a Stirling cycle engine including: a casing; a cylinder housed within the casing; a piston capable of being reciprocated inside said cylinder; a displacer capable of being reciprocated with a phase difference relative to the piston; a compression chamber defined between the piston and the displacer; an expansion chamber arranged on a first side of the displacer with a second side thereof opposite to the compression chamber; a heat exhausting unit arranged in the neighborhood of the compression chamber; a heat absorbing unit arranged in the neighborhood of the expansion chamber; a regenerator arranged between the heat exhausting unit and the heat absorbing unit; and a heat exhausting chamber defined between an outer surface of the casing and an inner surface of the heat exhausting unit, a first passage provided in the casing for communicating said heat exhausting chamber with said compression chamber; and a second passage provided in the casing for communicating said heat exhausting chamber with said regenerator.

A second aspect of the present invention is a Stirling cycle engine as set forth in the first aspect further including heat exhausting fins arranged inside of the heat exhausting chamber, said heat exhausting fins being thermally conductively in contact with the heat exhausting unit.

According to the first aspect of the present invention and by virtue of the above-described configuration of the Stirling cycle engine, there can be exhausted a heat, generated in the compression chamber, from the heat exhausting unit to the outside without passing through the casing. For this reason, thickness of the casing causes little effect on the heat exhausting efficiency, thereby allowing the casing to be thickly designed in light of pressure resistance and workability.

Moreover, the Stirling cycle engine, according to the second aspect of the present invention, is provided with heat exhausting fins that are thermally conductively in contact with the heat exhausting unit. By virtue of this configuration, the heat inside the compression chamber can be exhausted in a more efficient manner from the heat exhausting unit to the outside.

### BRIEF DESCRIPTION OF THE DRAWINGS

FIG. 1 illustrates a front view showing a Stirling cycle engine of a preferred embodiment of the present invention.

FIG. 2 illustrates a vertical cross-sectional view of a main section of the Stirling cycle engine of the preferred embodiment of the present invention.

FIG. 3A illustrates a transverse cross-sectional view of a heat exhausting unit and a heat exhausting chamber of the Stirling cycle engine of the preferred embodiment of the present invention.

FIG. 3B illustrates an enlarged view of an essential part of the components illustrated in FIG. 3A.

FIG. 4 illustrates a plane view of the Stirling cycle engine of the preferred embodiment of the present invention.

FIG. 5 illustrates a bottom plan view of the Stirling cycle engine of the preferred embodiment of the present invention.

### DETAILED DESCRIPTION OF THE PREFERRED EMBODIMENTS

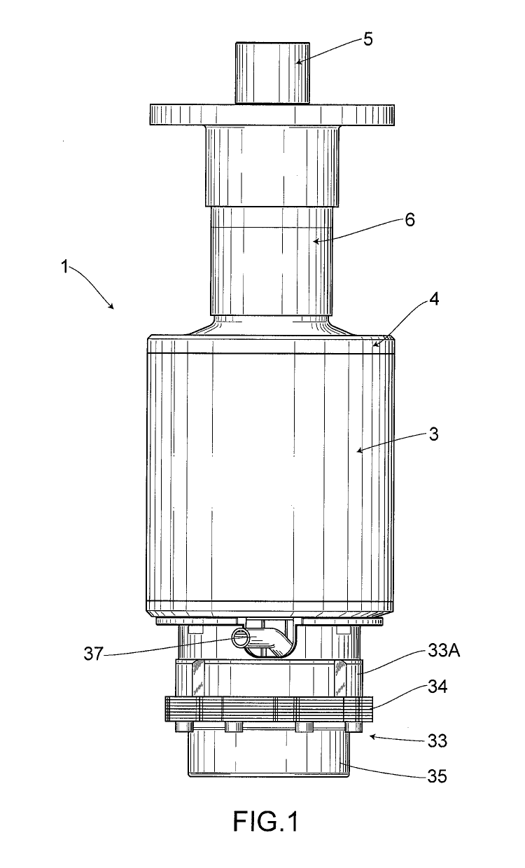

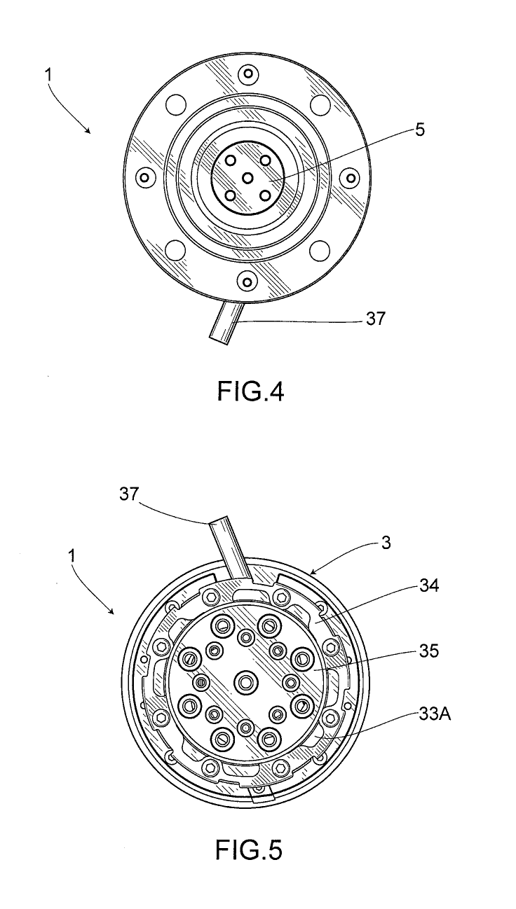

Preferred embodiments of the present invention will now be described hereunder with reference to the accompanying FIGS. 1 to 5. The following embodiments shall not limit the contents of the present invention that are described in the claims. Further, not all elements described hereunder are necessarily the essential elements of the present invention.

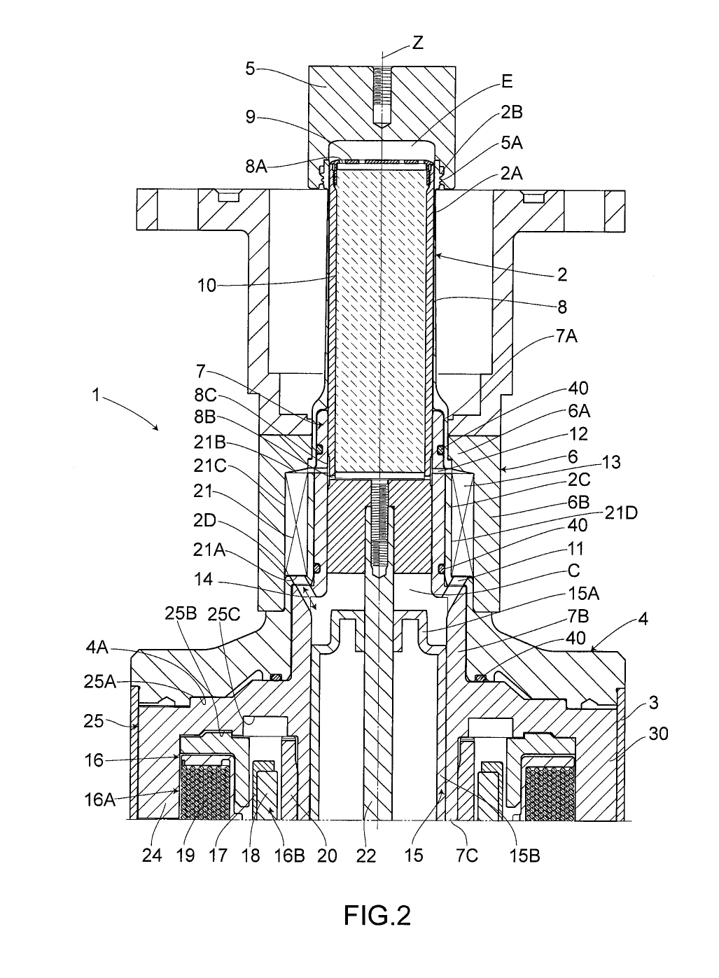

As illustrated in FIGS. 1 and 2, numeral 1 denotes a casing including a cylindrically shaped cylindrical portion 2, a body portion 3, a coupling member 4, a heat absorbing unit 5, and a hermetic seal (not shown). The cylindrical portion 2, the body portion 3 and the coupling member 4 are formed of a stainless steel material or the like. The cylindrical portion 2 and the coupling member 4 are integrally formed with each other. Further, the hermetic seal is formed of a metal such as copper. The heat absorbing unit 5 is formed of a metal such as copper.

The top and bottom ends of the cylindrical portion 2 are open, and on the outer periphery of a distal portion 2A thereof is formed an external thread 2B. The inner surface thereof is subjected to cutting work in such a manner that the cross-section of the distal portion 2A is precisely formed to be circular. By virtue of this configuration, the inner surface of the distal portion 2A of the cylindrical portion 2 serves as a cylinder.

On the heat absorbing unit 5 is formed an internal thread 5A engageable with the external thread 2B. Also, the body portion 3 is connected to a coupling member 4 having a substantially ring shape through, e.g., brazing, and the body portion 3 and the hermetic seal are connected to each other through, e.g., brazing. The distal portion 2A of the cylindrical portion 2 is screwed into the heat absorbing unit 5 through the external thread 2B and the internal thread 5A, which are to be brazed to form the casing 1. An open ended section of the cylindrical portion 2 is covered by the heat absorbing unit 5 in a tightly sealing manner.

On the proximal end side of the cylindrical portion 2, a cylinder 7, made of aluminum alloy and extended up to the inside of the body portion 3, is interposed coaxially with respect to the cylindrical portion 2 and the coupling member 4, or to axis Z. Further, on the outer surface of a middle portion 7B of the cylinder 7, there is provided a mount 25 from which extends connecting arms 30 toward the body portion 3. The cylinder 7 and the mount 25 are formed by casting, such as die casting or the like, using an aluminum alloy or the like, followed by subjecting them to cutting work after casting. The mount 25 and the connecting arms 30 are preferably formed in one piece but may be formed as separate members.

A displacer 8 of a hollow cylindrical shape is slidably accommodated inside the extended portion of the cylinder 7 and the distal portion 2A of the cylindrical portion 2, the displacer 8 being slidable in the direction of the axis Z. Also, an expansion chamber E is formed between a distal end of the displacer 8 and the heat absorbing unit 5. Further, on the distal end of the displacer 8 is mounted a lid 9 through which a plurality of vent holes 8A are formed. The expansion chamber E is in communication with the inside of the displacer 8 through these vent holes 8A. The vent holes 8A put inside of the displacer 8 in communication with the expansion chamber E. Furthermore, there are formed a plurality of vent holes 8B on a proximal portion of the displacer 8. On the proximal portion of the displacer 8, there is formed an annular shallow groove 8C having a width, in the direction of Z axis, larger than the stroke length of the displacer, and through this groove 8C are formed the vent holes 8B. The displacer 8 is made of synthetic resin.

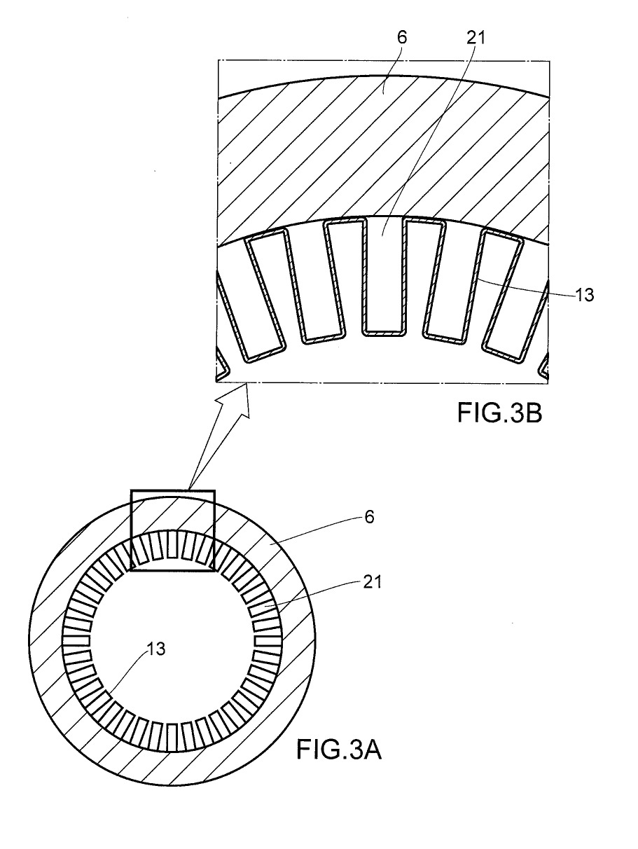

Between the outer surface of the cylindrical portion 2 and the inner surface of the heat exhausting unit 6, there is formed a cylindrical heat exhausting chamber 21. The outer surface of a step 2D of the cylindrical portion 2 delimits a lower surface portion 21A of the heat exhausting chamber 21. Moreover, the inner surface of the upper side portion 6A of the heat exhausting unit 6 delimits an upper surface portion 21B of the heat exhausting chamber 21. Further, the inner surface of a lower side portion 6B of the heat exhausting unit 6 delimits an outer side surface portion 21C of the heat exhausting chamber 21. Furthermore, the outer surface of an enlarged diameter part 2C of the cylindrical portion 2 delimits an inner side surface portion 21D of the heat exhausting chamber 21. As illustrated by FIG. 2 and FIGS. 3A and 3B, inside this heat exhausting chamber 21 is provided heat exhausting fins 13. This heat exhausting fin 13 is of a type so-called corrugated fins that are formed through bending of a copper plate. Note that the outer surface of the heat exhausting fins 13 are thermally conductively in contact with the inner surface of the heat exhausting unit 6. By virtue of the provision of the heat exhausting fin 13 inside the heat exhausting chamber 21, there can be increased an area contacted by operating gas, thus efficiently transferring the heat of the operating gas from the heat exhausting fins 13 to the heat exhausting unit 6. Further, in between the adjacent ridges of the folded plates making up the heat exhausting fins 13 are formed gaps running parallel to the moving direction of the operating gas, thus allowing the operating gas to move smoothly through the heat exhausting chamber 21.

A lower portion of the heat exhausting chamber 21 is communicated with the compression chamber C through a first passage 11 formed in the step 2D of the cylindrical portion 2 and the cylinder 7. An upper portion of the heat exhausting chamber 21 is communicated with the inside of the displacer 8 through a second passage 12 formed in the cylindrical portion 2 and the cylinder 7. As described above, the displacer 8 is formed with a groove 8C on which the vent holes 8B are provided, allowing the vent holes 8B and the second passage 12 to be communicated with each other irrespective of the position of the reciprocating displacer 8. Further, inside the displacer 8 is provided a regenerator 10.

In this way, there is formed a path 14 extending from the expansion chamber E up to the compression chamber C within the cylinder 7 through the vent holes 8A, regenerator 10, vent holes 8B, second passage 12, heat exhausting chamber 21 and the first passage 11. Helium, serving as an operating gas, circulates through this path.

The heat exhausting unit 6, as described above, is integrally formed with the upper side portion 6A and the lower side portion 6B, and has a cylindrical shape whose top and bottom ends are open. The upper side portion 6A extend inwardly, from the upper edge of the lower side portion 6B, to form a flange shape. As a result, the inner diameter of the upper side portion 6A is formed smaller than that of the lower side portion 6B. Further, as described above, this heat exhausting unit 6 delimits the upper surface portion 21B and outer side surface portion 21C of the heat exhausting chamber 21. Here, the lower side portion 6B of the heat exhausting unit 6 is formed longer, in the vertical direction, than the heat exhausting chamber 21. The inner edge of the upper side portion 6A of the heat exhausting unit 6 is hermetically attached to the outer surface of the cylindrical portion 2 through brazing or the like while the lower edge of the lower side portion 6B of the heat exhausting unit 6 is attached to the outer surface of the coupling member 4 through brazing or the like. The heat exhausting unit 6 is made of a metal, such as copper, having high thermal conductivity. Further, there are provided heat exhausting fins 13 that are thermally conductively in contact with the inner surface of this heat exhausting unit 6. By virtue of this configuration, a heat produced at the heat exhausting chamber 21 can be efficiently exhausted to the outside through the heat exhausting fins 13 and the heat exhausting unit 6.

Within the enlarged diameter part 2C of the cylindrical portion 2 is housed an extended section 7A of the cylinder. Further, within the coupling member 4 is housed the middle portion 7B of the cylinder 7. Inside the cylinder 7 extending from the middle portion 7B to a proximal portion 7C thereof, a piston 15 is slidably housed in the direction of axis Z. Note that the tip 15A of the piston 15 is allowed to be fit into the extended section 7A of the cylinder during operation. The proximal portion 15B of the piston 15 is slidably in contact with an inner surface of the cylinder 7, said inner surface extending from the middle portion 7B to the proximal portion 7C of the cylinder 7. Further, the piston 15 is coaxially connected (in the direction of axis Z) to a stator 16B of the drive mechanism 16.

Further, to a basal side of the displacer 8 is connected one end of a rod 22 for controlling the movement of the displacer 8. This rod 22 extends in a manner penetrating through the piston 15.

The drive mechanism 16 is configured to have a stator 16A and a mover 16B. Also, the stator 16A is configured to have an electromagnetic coil 19, an inner core and an outer core 24. The mover 16B includes a frame 17 and a permanent magnet 18. The outer core 24 is provided on the surrounding of the electromagnetic coil 19. This outer core 24 is normally made of ferromagnetic iron powder to be formed into a desired shape before being sintered where the outer core is covered in advance by an insulator (e.g., of synthetic resin or ceramics). Alternatively, the outer core 24 may be formed by laminating a plurality of magnetic steel sheets having a suitable shape. Similarly, the inner core 20 is normally made of ferromagnetic iron powder to be formed into a desired shape before being sintered where the inner core is covered in advance by an insulator (e.g., of synthetic resin or ceramics). Alternatively, the inner core 20 may be formed by laminating a plurality of magnetic steel sheets having a suitable shape. The frame 17 has a shape of short cylinder. To one end of this frame 17 is fixed a permanent magnet 18. Further, the frame 17 is concentrically connected to the proximal portion 15B of the piston. The inner surface of the outer core 24 of the stator 16A is located in proximity to the outer circumference of the permanent magnet 18, and the outer surface of the inner core 20 is located in proximity to the inner side of the permanent magnet 18.

As described above, the cylinder 7 is integrally formed with a flange-shaped mount 25 that is coaxially protruded in a concentric manner from the middle portion 7B of the cylinder 7. The mount 25 is configured in such a manner that a first side surface 25A of the mount 25 is abutted against and screwed on to a mounting section 4A of the coupling member 4. Meanwhile, on a second side surface 25B of the mount 25, there is formed an annular concave groove 25C. Also, a plurality of connecting arms 30 are protruded from the mount 25 toward the direction substantially in parallel with the Z axis of the cylinder 7. Note that a numeral “40” illustrated in the accompanying drawings represents an O-ring serving as a packing for sealing a gap between the outer surface of the cylinder 7 and the inner surface of the casing 1.

At a lower part of the casing 1 is provided a vibration absorbing unit 33 which is arranged in a manner such that the flat springs 34 are coaxially mounted next to the balance weight 35 through a coupling member 33A disposed on the axial line of the cylinder 7. Here, within the vibration absorbing unit 33, there is provided a power connector (not shown), for supplying power to the driving mechanism 16, connected to the hermetic seal (not shown). Numeral 37 denotes a pipe for the infusion of an operating gas.

Next, there will be described a manufacturing process of the Stirling cycle engine of the present embodiment. First, a copper plate is folded into ridges to form a corrugated fin, which is then rolled into a short cylindrical shape to form heat exhausting fins 13 arranged annularly.

The heat exhausting fins 13, formed in this manner, are then inserted into the heat exhausting unit 6 where the outer surfaces of the heat exhausting fins 13 are thermally conductively in contact with the inner surface of the lower side portion 6B of the heat exhausting unit 6. Then, a cylindrical portion 2 is inserted into the heat exhausting unit 6 provided with heat exhausting fins 13 from the lower side portion 6B thereof. Once the cylindrical portion 2 is inserted thereinto to the full extent, an inner circumferential edge of the upper side portion 6A of the heat exhausting unit 6 gets in close contact with the outer surface of the enlarged diameter part 2C of the cylindrical portion 2. Meanwhile, the lower end portion of the lower side portion 6B of the heat exhausting unit 6 is in close contact with the outer surface of the coupling member 4. With this arrangement, the inner circumferential edge of the upper side portion 6A is hermetically brazed to the outer surface of the enlarged diameter part 2C of the cylindrical portion 2, and the lower end portion of the lower side portion 6B is hermetically brazed to the outer surface of the coupling member 4. In this manner, there is defined a heat exhausting chamber 21 between the casing 1 and the heat exhausting unit 6. Then, to the distal end of the cylindrical portion 2 is attached a heat absorbing unit 5. In this way, the cylinder portion 2 is integrally formed with the coupling member 4, the heat absorbing unit 5, the heat exhausting unit 6 and the heat exhausting fins 13. Also, the body portion 3 is connected to the hermetic seal in advance to be integrated with each other. Further, the mount 25 gets screwed-on to the coupling member 4 in order to fix the cylinder 7 to the casing 1. Here, the extended section 7A of the cylinder 7 is guided into the enlarged part 2C of the cylindrical portion 2 in a manner such that the outer surface of the extended section 7A gets slidably in contact with the inner surface of the enlarged diameter part 2C thereof. This way, the cylinder 7 can be coaxially arranged with respect to the cylindrical portion 2. Further, the position of the cylinder 7 with respect to the cylindrical portion 2 is determined so as to match the location of the holes formed on the cylinder to that of the holes on the cylindrical portion 2, thus providing a first passage 11 and a second passage 12. Then, there are fixed an electromagnetic coil 19 and an outer core 24 to the mount 25 that is integrally formed with the cylinder 7. Further, to the outer periphery of the proximal portion 7C of the cylinder 7 is fixed an inner core 20. In this manner, a stator 16A of the drive mechanism 16 is fixed to the cylinder 7. Furthermore, a frame 17, with a permanent magnet 18 being insert-molded, is sandwiched between the proximal end of the piston 15 and a connector (not shown) to fix the mover 16B of the drive mechanism 16. Furthermore, within the cylinder 7 are mounted a displacer 8 and a piston 15 or the like. Then, the body portion 3 and the coupling member 4 are connected to be integrated with each other, and to the body portion 3 is attached a vibration absorbing unit 33 that is assembled in advance.

Next is an explanation of the action of the present embodiment. By applying an alternating current to the electromagnetic coil 19 this way, an alternating magnetic field will be generated from the electromagnetic coil 19 and be concentrated around the stator 24. This alternating magnetic field then generates a force to reciprocate the permanent magnet 18 along the direction of Z axis. Due to this force, the piston 15, connected to frame 17 to which the permanent magnet 18 is fixed, will start reciprocating within the cylinder 7 along the direction of Z axis. When the piston 15 comes closer to the displacer 8, a gas, which is in the compression chamber C disposed between the piston 15 and the displacer 8, is compressed and flows into the expansion chamber E provided within the heat absorbing unit 5, through the first passage 11, the heat exhausting chamber 21, the second passage 12, the groove 8C, the vent holes 8B, the regenerator 10, and the vent holes 8A. Consequently, the displacer 8 is pushed downwardly toward the piston 15 with a phase difference relative to the piston 15. On the other hand, when the piston 15 moves away from the displacer 8, the inside of the compression chamber C is subjected to negative pressure, and the gas within the expansion chamber E flows back from the expansion chamber E to the compression chamber C through the vent holes 8A, the regenerator 10, the vent holes 8B, the groove 8C, the second passage 12, the heat exhausting chamber 21, and the first passage 11. Accordingly, the displacer 8 is pressed upwardly away from the piston 15 with the phase difference relative to the piston 15. Throughout these processes, a reversible cycle, consisting of two changes of an isothermal change and an isochoric change, will be carried out. Consequently, the neighborhood of the expansion chamber E is brought into a low-temperature state and the neighborhood of the compression chamber C is brought into a high-temperature state.

Here, during the operation of this Stirling cycle engine, operating gas, heated in the compression chamber C to a high temperature, moves into the heat exhausting chamber 21 through the first passage 11. The heat of the high-temperature operating gas then gets transported through the heat exhausting fins 13 to the heat exhausting unit 6, and to the outside through the heat exhausting unit 6. Note that the heat of the operating gas is directly conducted to the heat exhausting fins 13 of copper exhibiting favorable thermal conductivity through which the heat is then conducted to the heat exhausting unit 6 of copper also exhibiting favorable thermal conductivity, thereby allowing favorable heat exhaustion. Conventional Stirring engines are configured to exhaust a heat through a casing of stainless steel material. For this reason, the casing of such engines has little choice but to be thinly formed in consideration of heat exhausting efficiency. The Stirling cycle engine of the present invention, on the other hand, is so configured such that the thickness of the cylindrical portion 2 of the casing 1 causes little effect on the heat exhausting efficiency, thereby allowing cylindrical portion 2 of the casing to be thickly designed in light of pressure resistance and workability. Further, the Stirling cycle engine of the present invention is provided with heat exhausting fins 13 on the inner surface of the heat exhausting unit 6 that constitutes a part of the heat exhausting chamber 21, thereby allowing a heat of the compression chamber C to be efficiently exhausted from the heat exhausting fins 13 through the heat exhausting unit 6 to the outside.

As described above, the Stirling cycle engine of the present invention includes: a casing 1; a cylinder 7 housed within the casing 1; a piston 15 capable of being reciprocated inside said cylinder 7; a displacer 8 capable of being reciprocated with a phase difference relative to the piston 15; a compression chamber C defined between the piston 15 and the displacer 8; an expansion chamber E arranged on a first side of the displacer 8 with a second side thereof opposite to the compression chamber C; a heat exhausting unit 6 arranged in the neighborhood of the compression chamber C; a heat absorbing unit 5 arranged in the neighborhood of the expansion chamber E; a regenerator 10 arranged between the heat exhausting unit 6 and the heat absorbing unit 5; and a heat exhausting chamber 21 defined between an outer surface of the casing 1 and an inner surface of the heat exhausting unit 6, said heat exhausting chamber 21 in communication with the compression chamber C and the regenerator 10 respectively through a first passage 11 and a second passage 12 that are provided in the casing 1 and the cylinder 7. By virtue of this configuration, a gas compressed in the compression chamber C gets transported through the first passage 11 to the heat exhausting chamber 21 provided outside of the casing 1, allowing the heat of the compressed gas to be conducted through the heat exhausting fins 13 to the heat exhausting unit 6, thereby allowing efficient heat exhaustion through the heat exhausting unit 6 to the outside of the Stirling cycle engine. Moreover, the Stirling cycle engine of the present invention is configured in such a manner that the gas, compressed in the compression chamber C, gets transported through the first passage 11 to the heat exhausting chamber 21 arranged outside of the casing. By virtue of this configuration, the shape or thickness of the cylindrical portion 2 of the casing 1 causes little effect on the heat exhausting efficiency thereof, thereby allowing cylindrical portion 2 of the casing 1 to be thickly designed in light of pressure resistance and workability.

Further, inside of the heat exhausting chamber 21, there are provided heat exhausting fins 13 being thermally conductively in contact with the heat exhausting unit 6. By virtue of this configuration, there can be transferred a heat in an efficient manner from the gas compressed in the compression chamber C to the heat exhausting fins 13, thereby enhancing heat exhausting efficiency of the Stirling cycle engine.

It should be construed that the present invention shall not be limited to the embodiments as described above, and many variations and modifications can be made within the scope of the present invention. For example, the regenerator 10 may be provided on the outer periphery of the displacer 8, without being limited to the above embodiment where the regenerator 10 is arranged inside of the displacer 8. Further, the cylinder 7 may be extended up to the middle portion 7B, and the first passage 11 and the second passage 12 may be present only on the cylindrical portion 2. Further, the heat exhausting fins 13 may have a structure other than corrugated fins.

What is claimed:

1. A Stirling cycle engine comprising:
a casing;
a cylinder housed within the casing;
a piston capable of being reciprocated inside said cylinder;
a displacer capable of being reciprocated with a phase difference relative to the piston;
a compression chamber defined between the piston and the displacer;
an expansion chamber arranged on a first side of the displacer with a second side thereof opposite to the compression chamber;
a heat exhausting unit arranged in the neighborhood of the compression chamber;
a heat absorbing unit arranged in the neighborhood of the expansion chamber;
a regenerator arranged between the heat exhausting unit and the heat absorbing unit;
a heat exhausting chamber defined between an outer surface of the casing and an inner surface of the heat exhausting unit,
a first passage provided in the casing for communicating said heat exhausting chamber with said compression chamber; and
a second passage provided in the casing for communicating said heat exhausting chamber with said regenerator.

2. The Stirling cycle engine according to claim 1, further comprising heat exhausting fins arranged inside of the heat exhausting chamber, said heat exhausting fins being thermally conductively in contact with the heat exhausting unit.

3. The Stirling cycle engine according to claim 2, wherein the heat exhausting fins comprise a corrugated fin formed of a plate folded into ridges.

4. The Stirling cycle engine according to claim 2, wherein the heat exhausting unit has a cylindrical shape and the heat exhausting fins are arranged annularly therealong to form a short cylindrical array.

5. The Stirling cycle engine according to claim 3, wherein the heat exhausting unit has a cylindrical shape and the heat exhausting fins are arranged annularly therealong to form a short cylindrical array.

6. The Stirling cycle engine according to claim 3, wherein in-between the adjacent ridges of the folded plate making up the heat exhausting fins are defined gaps running parallel to a moving direction of an working gas circulating through the heat exhausting chamber.

7. The Stirling cycle engine according to claim 5, wherein in-between the adjacent ridges of the folded plate making up the heat exhausting fins are defined gaps running parallel to a moving direction of an working gas circulating through the heat exhausting chamber.

8. The Stirling cycle engine according to claim 1, wherein on a proximal portion of the displacer are formed vent holes and an annular groove that has a width larger than the stroke length of the displacer, said vent holes being in communication with the second passage via the annular groove.

9. The Stirling cycle engine according to claim 2, wherein on a proximal portion of the displacer are formed vent holes and an annular groove that has a width larger than the stroke length of the displacer, said vent holes being in communication with the second passage via the annular groove.

10. The Stirling cycle engine according to claim 3, wherein on a proximal portion of the displacer are formed vent holes and an annular groove that has a width larger than the stroke length of the displacer, said vent holes being in communication with the second passage via the annular groove.

11. The Stirling cycle engine according to claim 4, wherein on a proximal portion of the displacer are formed vent holes and an annular groove that has a width larger than the stroke length of the displacer, said vent holes being in communication with the second passage via the annular groove.

12. The Stirling cycle engine according to claim 5, wherein on a proximal portion of the displacer are formed vent holes and an annular groove that has a width larger than the stroke length of the displacer, said vent holes being in communication with the second passage via the annular groove.

13. The Stirling cycle engine according to claim 6, wherein on a proximal portion of the displacer are formed vent holes and an annular groove that has a width larger than the stroke length of the displacer, said vent holes being in communication with the second passage via the annular groove.

14. The Stirling cycle engine according to claim 7, wherein on a proximal portion of the displacer are formed vent holes and an annular groove that has a width larger than the stroke length of the displacer, said vent holes being in communication with the second passage via the annular groove.
